(19) United States
(12) Patent Application Publication
(10) Pub. No.: US 2025/0258783 A1
(43) Pub. Date: Aug. 14, 2025

(54) INTERFACE DEVICE AND METHOD, DATA COMPUTING DEVICE AND DATA PROCESSING SYSTEM INCLUDING THE SAME

(71) Applicant: SK hynix Inc., Gyeonggi-do (KR)

(72) Inventor: Joon Seop SIM, Gyeonggi-do (KR)

(21) Appl. No.: 19/192,367

(22) Filed: Apr. 29, 2025

Related U.S. Application Data
(63) Continuation-in-part of application No. 18/352,255, filed on Jul. 14, 2023.

(30) Foreign Application Priority Data
Jan. 18, 2023 (KR) 10-2023-0007476

(51) Int. Cl. G06F 13/16; G06F 13/42

(52) U.S. Cl. CPC G06F 13/1663; G06F 13/1668; G06F 13/4282

(57) ABSTRACT

An interface device may communicate between a first device and a second device. The interface device may comprise a first element configured to receive a first packet from the first device based on a first protocol and transmit the first packet to the second device, wherein the first packet includes a command, and a second element configured to receive a second packet from the first device based on a second protocol different from the first protocol and transmit the second packet to the second device, wherein the second packet includes a command address representing a storage position of the command.

### CROSS-REFERENCES TO RELATED APPLICATION

The present application is a continuation-in-part application of pending U.S. patent application Ser. No. 18/352,255, filed on Jul. 14, 2023, which claims priority under 35 U.S.C. § 119 (a) to Korean application number 10-2023-0007476, filed on Jan. 18, 2023, in the Korean Intellectual Property Office, which applications are incorporated herein by reference in their entirety.

### BACKGROUND

### 1. Technical Field

Various embodiments of the present disclosure generally relate to an electronic device, more particularly, to an interface device and method, a data computing device and a data processing system including the same.

### 2. Related Art

An electronic device configured to store and compute data in a memory may include a host device and a slave device including the memory. The host device and the slave device may be connected to each other through various standard interface protocols.

Due to a rapid and high capacitated data processing that may be required, a rapid operation of the interface protocol connected between the host device and the slave device or an interface device including the interface protocol is becoming a concern.

### SUMMARY

According to embodiments of the present disclosure, there may be provided an interface device. The interface device may be communicated between a first device and a second device. The interface device may comprise a first element configured to receive a first packet from the first device based on a first protocol and transmit the first packet to the second device, wherein the first packet includes a command, and a second element configured to receive a second packet from the first device based on a second protocol different from the first protocol and transmit the second packet to the second device, wherein the second packet includes a command address representing a storage position of the command.

According to embodiments of the present disclosure, there may be provided a data computing device. The data computing device may include an interface device configured to receive a first packet from a first device based on a first protocol and to receive a second packet from the first device based on a second protocol different from the first protocol, wherein the first packet includes a command, and the second packet includes a command address representing a storage position of the command; a device memory including the storage position; a processor configured to parse the first packet to extract the command and to store the command in the device memory and parse the second packet to extract the command address; and a memory controller configured to access to the device memory based on the command address parsed by the processor to execute the command.

According to embodiments of the present disclosure, there may be provided a data processing system. The data processing system may include a first device; and a second device, wherein the second device comprises an interface device and a processor, wherein the interface device is configured to: receive an off-road calculation request from the first device, receive a first packet based on a first protocol, and receive a second packet from the first device based on a second protocol different from the first protocol, the first packet including a command, the second packet including a command address representing a storage position of the command, and wherein the processor is configured to: parse the first packet and the second packet to process the off-road calculation request.

According to embodiments of the present disclosure, there may be provided an interface method between a first device and a second device. In the interface method, receiving a first packet from the first device based on a first protocol by the second device, wherein the first packet includes a command; and receiving a second packet from the first device based on a second protocol different from the first protocol by the second device, wherein the second packet includes a command address representing a storage position of the command.

### BRIEF DESCRIPTION OF THE DRAWINGS

The above and other aspects, features and advantages of the subject matter of the present disclosure will be more clearly from the following detailed description taken in understood f conjunction with the accompanying drawings, in which:

FIG. 1 is a view illustrating a data processing system in accordance with embodiments of the present disclosure;

FIG. 2 is a view illustrating an interconnection between devices of a data processing system in accordance with embodiments of the present disclosure;

FIG. 3 is a view illustrating a data processing system in accordance with embodiments of the present disclosure; and

FIGS. 4 and 5 are views illustrating packets transmitted and received between devices in accordance with embodiments of the present disclosure.

### DETAILED DESCRIPTION

Various embodiments of the present disclosure will be described in greater detail with reference to the accompanying drawings. The drawings are schematic illustrations of various embodiments (and intermediate structures). As such, variations from the configurations and shapes of the illustrations as a result, for example, of manufacturing techniques and/or tolerances, are to be expected. Thus, the described embodiments should not be construed as being limited to the particular configurations and shapes illustrated herein but may include deviations in configurations and shapes which do not depart from the spirit and scope of the present disclosure as defined in the appended claims.

Embodiments of the present disclosure are described herein with reference to cross-section and/or plan illustrations. However, embodiments of the present disclosure should not be construed as limiting the inventive concept. Although a few embodiments of the present disclosure will be shown and described, it will be appreciated by those of ordinary skill in the art that changes may be made in these embodiments without departing from the principles and spirit of the present disclosure.

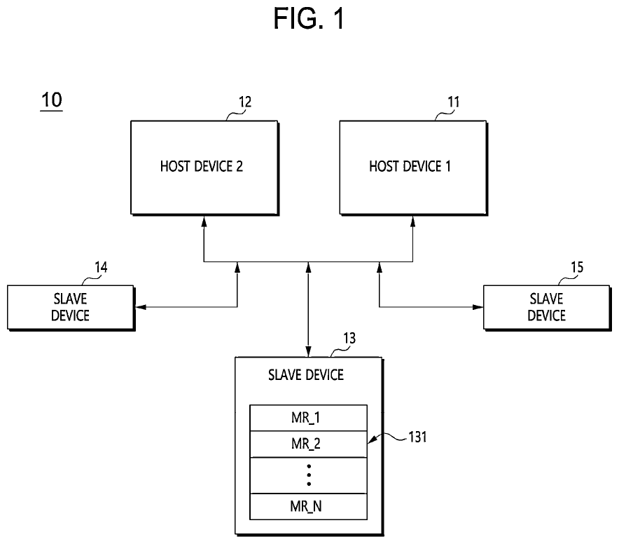

FIG. 1 is a view illustrating a data processing system 10 in accordance with some embodiments of the present disclosure.

Referring to FIG. 1, the data processing system 10 may include host devices 11 and 12 and slave devices 13, 14 and 15. Each of the host devices 11 and 12 may request an access with respect to the slave devices 13, 14 and 15. In some embodiments, the slave devices 13, 14 and 15 may include memory devices.

The slave devices 13, 14 and 15 may include various types of memories. For example, the slave devices 13, 14 and 15 may include a non-volatile memory such as a solid state drive (SSD), a flash memory, a Magnetic RAM (MRAM), a Ferroelectric RAM (FRAM), a Phase change RAM (PRAM), a Resistive RAM (RRAM), a dynamic random access memory (DRAM) such as a Double Data Rate Synchronous Dynamic Random Access Memory (DDR SDRAM), a Low Power Double Data Rate (LPDDR) SDRAM, a Graphics Double Data Rate (GDDR) SDRAM, a Rambus Dynamic Random Access Memory (RDRAM), etc.

At least one of the slave devices 13, 14 and 15 may include a plurality of memory regions logically and/or physically divided from each other. For example, the first slave device 13 may include a memory device 131 having a plurality of memory regions MR_1 to MR_N. Similarly, the slave devices 14 and 15 may include a memory similar to the memory device 131.

The memory regions MR_1 to MR_N may correspond to logical devices logically divided from each other. The memory regions MR_1 to MR_N in the first slave device 13 may be recognized as a plurality of devices in the data processing system 10. The memory regions MR_1 to MR_N may be independently accessed by the different host devices 11 and 12.

The devices 11, 12, 13, 14 and 15 in the data processing system 10 may communicate with each other through an interconnection or a link for supporting at least one protocol. Each of the devices 11, 12, 13, 14 and 15 may include internal elements configured to perform a protocol-based communication supported by the interconnection. For example, the interconnection may support at least one protocol such as Peripheral Component Interconnect Express (PCIe), compute express link (CXL), XBus, NVLink, Infinity Fabric, cache coherent interconnect for accelerators (CCIX), coherent accelerator processor interface (CAPI), etc.

FIG. 1 may show the interconnection between the devices 11, 12, 13, 14 and 15. The devices 11, 12, 13, 14 and 15 may communicate with each other through a root complex. The root complex may manage a transaction between the devices 11, 12, 13, 14 and 15.

Hereinafter, a CXL protocol-based communication of some embodiments may be described without limitation. In some embodiments, the devices 11, 12, 13, 14 and 15 may communicate with each other based on various configurations and functions in accordance with a CXL standard. Particularly, the devices 11, 12, 13, 14 and 15 may communicate with each other through various protocols based on configurations including a flex bus, a switch, etc., in the CXL standard. In an embodiment, various other protocols may also be applied to the devices 11, 12, 13, 14 and 15.

In an embodiment, at least one of the first to third slave devices 13, 14 and 15 may be connected with the first host device 11 and/or the second host device 12 through a protocol-based bridge, for example, a PCI bridge for controlling a communication path.

The first host device 11 and the second host device 12 may include various types of devices. For example, the first host device 11 and the second host device 12 may be a main processor including at least one of a programmable element such as a central processing unit (CPU), a graphic processing unit (GPU), a neural processing unit (NPU), etc., an element configured to provide a fixed function such as an intellectual property (IP), a reconfigurable element such as a field programmable gate array (FPGA) and a peripheral device such as a network interface card (NIC).

The slave devices 13, 14 and 15 may be an accelerator such as a GPU, an NPU, a FPGA, etc., configured to process requests of the host devices 11 and 12. In some embodiments, the host devices 11 and 12 may off-road a calculation having a lot of memory accesses to the slave devices 13, 14 and 15. In an embodiment, the slave devices 13, 14 and 15 may be a near data processor (NDP) configured to store data required for the calculation in the memory device 131 in accordance with the request of the host devices 11 and 12 and to store calculation results associated with the data used for the calculation in the memory device 131.

In some embodiments, at least one of the first to third slave devices 13, 14 and 15 may be shared by the first and second host devices 11 and 12. For example, when the first slave device 13 may be shared by the first and second host devices 11 and 12, the first slave device 13 may store commands transmitted by the first and second host devices 11 and 12 or store data inputted for the calculation and/or calculation results which are associated with the commands and/or the data. The first slave device 13 may then transmit the calculation results to the first and second host devices 11 and 12.

The first and second host devices 11 and 12 and the first to third slave devices 13, 14 and 15 may generate and transmit packets in accordance with an applied protocol. For example, the first host device 11 or the second host device 12 may execute hierarchical software including an application to generate a packet. The first host device 11 or the second host device 12 may then select the slave devices 13, 14 and 15 to be accessed. The first host device 11 or the second host device 12 may generate a host packet and transmit the host packet to the selected slave device. In an embodiment, the host packet generated by the first host device 11 or the second host device 12 may include a command. The host packet may further include data stored in a memory device of the selected slaved devices 13, 14 and 15. In an embodiment, the host packet generated by the first host device 11 or the second host device 12 may include a command address indicating where the command is stored.

The slave devices 13, 14 and 15 receiving the host packet from the first host device 11 or the second host device 12 may parse the host packet to process an extracted command. The slave devices 13, 14 and 15 may generate a slave packet corresponding to a command processing result. The slave devices 13, 14 and 15 may then transfer the slave packet to the first host device 11 or the second host device 12 transmitting the host packet. In an embodiment, the slave packet may include a response with respect to the command or data generated as a result of processing the command, such as data read from the memory device of the slave devices 13, 14 and 15.

The slave devices 13, 14 and 15 may include a memory controller configured to process the host packet and generate the slave packet. In some embodiments, the memory controller may be provided within a device substantially the same as the memory device 131 or an additional device.

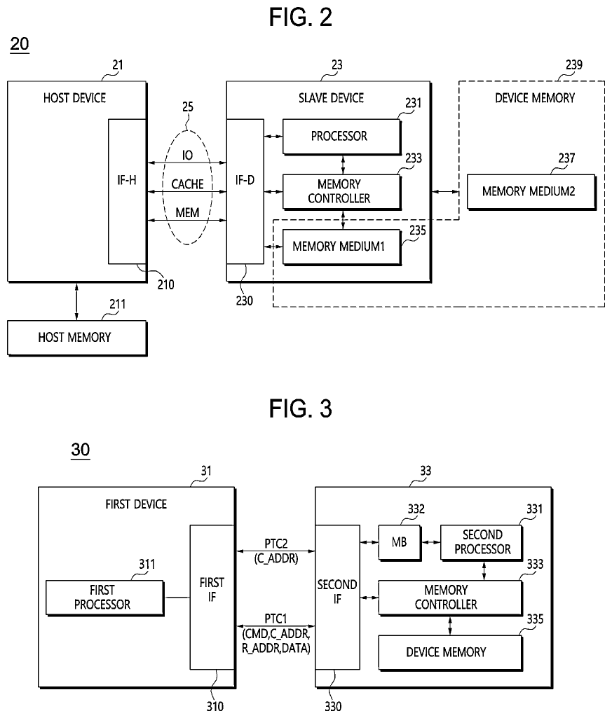

FIG. 2 is a view illustrating an interconnection between devices of a data processing system 20 in accordance with some embodiments of the present disclosure. In an embodiment, FIG. 2 shows an interconnect based on the CXL protocol.

Referring to FIG. 2, a host device 21 and a slave device 23 may communicate with each other through an interconnect 25 or a link configured to support at least one protocol. For example, the interconnect 25 may support at least one protocol of a peripheral component interconnect express (PCIe), a compute express link (CXL), an XBus, an NVLink, an infinity fabric, a cache coherent interconnect for accelerators (CCIX), a coherent accelerator processor interface (CAPI), etc. In an embodiment, FIG. 2 shows the interconnect 25 configured to support the CXL protocol.

A host memory 211 may be attached to the host device 21. The host device 21 may request a data access to the slave device 23.

The slave device 23 may be accessed by the host device 21. The slave device 23 may include an interface device (IF-D) 230, a processor 231, a memory controller 233 and a device memory 239. The device memory 239 may include a first memory MEMORY MEDIUM1 235 and/or a second memory MEMORY MEDIUM2 237. The first memory MEMORY MEDIUM1 235 may be provided within a device substantially the same as the processor 231, for example, the slave device 23. The second memory MEMORY MEDIUM2 237 may be provided within an additional device different from the processor 231. The host device 21 and the slave device 23 may transmit a message and/or data through a host interface device (IF-H) 210 and a device interface device (IF-D) 230. That is, the host interface device 210 and the device interface device 230 may interface or support the communication between the host device 21 and the slave device 23.

For example, the host interface device 210 in the host device 21 and the device interface device 230 in the slave device 23 may support a plurality of low-ranked protocols defined by the CXL protocol. The message and/or the data therebetween may be transmitted and received through the low-ranked protocols. In some embodiments, the low-ranked protocols may include a non-coherent protocol CXL.io, or an I/O protocol IO, a coherent protocol CXL.cache, or a cache protocol and a memory access protocol CXL.mem or a memory protocol MEM.

The I/O protocol CXL.io may be an input/output protocol similar to the PCIe. The host device 21 and the slave device 23 in the data processing system 20 may perform a device search, a connection, an initial setting, a virtualization register access, etc., based on the PCIe protocol or the I/O protocol CXL.io. In some embodiments, the I/O protocol CXL.io may provide a non-coherent road/store interface.

The cache protocol CXL.cache may be used for forming a cache consistency between the cache protocol and the host memory 211 when the slave device 23 may access the host device 21. In some embodiments, the cache protocol CXL.cache may include three channels including a request, a response and data.

The memory protocol CXL.mem may be used when the host device 21 may access the device memory 239 of the slave device 23.

The processor 231 may include an accelerator configured to provide a useful function to the host device 21. For example, the processor 231 may include at least one of a programmable element such as a central processing unit (CPU), a graphic processing unit (GPU), a neural processing unit (NPU), etc., an element configured to provide a fixed function such as an intellectual property (IP) and a reconfigurable element such as a field programmable gate array (FPGA).

The processor 231 may include a mail box inside or outside the processor 231. The mail box may be connected to the device interface device 230. A predetermined type of a message may be transmitted between the processor 231 and the host device 21 through the mail box.

The slave device 23 may include the memory controller 233 for accessing the device memory 239. The memory controller 233 may communicate with the device memory 239 based on a protocol independent or dependent upon the interconnect 25. The memory controller 233 may access to the device memory 239 in accordance with controls of the processor 231 to read or write the data. The memory controller 233 may provide an access of the host device 21 to the device memory 239 through the interconnect 25 as well as the access of the slave device 23 to the device memory 239. In some embodiments, the device memory 239 may correspond to a CXL-specific device attachment memory.

The slave devices 13, 14 and 15 in FIG. 1 may be accessed by the host device 21 and the slave device 23 in FIG. 2 and peripheral devices.

Devices accessed by the host devices 11, 12 and 21 through the CXL interconnect such as the slave devices 13, 14 and 15 in FIG. 1, the slave device 23 in FIG. 2, etc., may be defined by various names such as a CXL sub-system, a memory system, an in (near)-memory dedicated calculation unit, etc.

In order to solve a memory shortage of a host device such as a server system and an ineffective memory allotment in a cluster environment using an expansion and a disaggregation, the CXL protocol may receive attentions.

In order to overcome a limited bandwidth of the CXL, the host device 21 as the server system may off-road the calculation having the memory accesses to the slave device 23 as the calculation unit for the memory adjoin to reduce an amount of the data between the host device 21 and the slave device 23.

The host device 21 may transmit the command for off-roading the calculation to the slave device 23. The command transmitted to the slave device 23 from the host device 21 may have a size of no less than several kilobytes.

In order to effectively transmit the data and the command, a data processing system in FIG. 3 may be proposed.

FIG. 3 is a view illustrating a data processing system 30 in accordance with some embodiments of the present disclosure.

Referring to FIG. 3, the data processing system 30 may include a first device 31 and a second device 33.

The first device 31 may include a first interface (IF) device 310 and a first processor 311.

The second device 33 may include a second interface (IF) device 330, a second processor 331, a mail box (MB) 332, a memory controller 333 and a device memory 335.

The first interface device 310 and the second interface device 330 may interface or support a communication between the first device 31 and the second device 33.

For example, the first interface device 310 and the second interface device 330 may support a first protocol PTC1 and a second protocol PTC2 as a low protocol defined by the CXL protocol.

The second processor 331 may include an accelerator or a memory adjoin dedicated calculation unit configured to provide the first device 31 with a useful function.

The memory controller 333 may access the device memory 335 to read or write data in accordance with a control of the second processor 331. In some embodiments, the memory controller 333 may receive a command CMD from the first device 31 through the first protocol PTC1. Alternatively, the memory controller 333 may receive the command CMD and the data DATA from the first device 31 through the first protocol PTC1.

The mail box (MB) 332 may be connected to the second interface device 330. A predetermined type of a message may be transmitted between the mail box 332 and the first device 31 through the second protocol PTC2. In some embodiments, the mail box 332 may receive the command address C_ADDR from the first device 31 through the second protocol PTC2.

The command CMD may be an operation command for controlling the device memory 335 by the memory controller 333. The data DATA may be a value to be stored in the device memory 335 by the first device 31. The command address C_ADDR may indicate a stored position of the command CMD in the device memory 335.

In some embodiments, the first protocol PTC1 may include a memory access protocol CXL.mem or a memory protocol MEM. The first protocol PTC1 may be used when the first device 31 may access the device memory 335 of the second device 33.

In some embodiments, the second protocol PTC2 may include a non-coherent protocol CXL.io or an I/O protocol IO. The first device 31 and the second device 33 may perform a device search, a connection, an initial setting, a virtualization register access based on the second protocol PTC2.

Additionally, the first device 31 and the second device 33 may support a third protocol, for example, a coherent protocol CXL.cache or a cache protocol CACHE.

The first processor 311 of the first device 31 may off-road at least part of a calculation and/or an input/output related to an application execution.

In order to off-road the application execution, the first device 31 may transmit a first packet including the command CMD to the second device 33.

For example, the first interface device 310 of the first device 31 may generate the first packet including the command CMD, or the command CMD and the data DATA, which are outputted from the first processor 311. The first interface device 310 may then transmit the first packet to the second device 33.

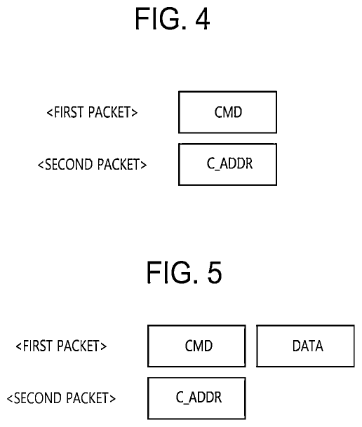

FIGS. 4 and 5 are views illustrating a packet transmitted and received between devices in accordance with embodiments of the present disclosure.

Referring to FIG. 4, the first packet may include the command CMD.

Referring to FIG. 5, the first packet may include the command CMD and the data DATA.

The first device 31 may generate an address allocation information by allocating a location to store the command CMD and data DATA based on a memory map of the device memory 335. The first device 31 may transmit the address allocation information by including it in the command CMD and data DATA, respectively.

The memory map may be information indicating the structure of the address space of the device memory (335), for example, whether memory space is allocated by address or address range, whether the address space is normal or bad, etc.

The second interface device 330 may parse the first packet shown in FIG. 4 to extract the command CMD.

In some embodiments, the second interface device 330 may control the memory controller 333 to store the command CMD in a position of the device memory 335 corresponding to the address allocation information including parsed command CMD. Thus, the memory controller 333 may store the command CMD in the position of the device memory 335 corresponding to the address allocation information.

In case that the first packet includes the command CMD and the data DATA shown in FIG. 5, the second interface device 330 may parse the first packet to extract the command CMD and the data DATA. The second interface device 330 may control the memory controller 333 to store the command CMD and data DATA in a position of the device memory 335 corresponding to the address allocation information including parsed command CMD and data DATA. Thus, the memory controller 333 may store the command CMD and data DATA in the position of the device memory 335 corresponding to the address allocation information.

Referring to FIGS. 4 and 5, the first interface device 310 of the first device 31 may generate a second packet including the command address C_ADDR. The first interface device 310 may then transmit the second packet to the second interface device 330 of the second device 33. The second packet may be stored in the mail box 332. When the mail box 332 receives the second packet, the mail box 332 may transmit an interrupt signal to the second processor 331. In an embodiment, the interrupt signal may be a signal for parsing and processing the second packet.

The second processor 331 may parse the second packet in the mail box 332 in response to the interrupt to extract the command address C_ADDR. The second processor 331 may control the memory controller 333 to execute the command CMD stored in the parsed command address C_ADDR.

Therefore, the memory controller 333 may access a position corresponding to the command address C_ADDR, and execute the read the command CMD.

When the command execution is completed, the memory controller 333 may generate the third packet for instructing the completion of the command execution. The memory controller 333 may then transmit the third packet to the first device 31 through the second interface device 310. The third packet may be stored in the mail box 332.

According to some embodiments, the command CMD may be written in the device memory 335 using the first protocol PTC1, for example, the memory access protocol CXL.mem or the memory protocol MEM among the low-ranked protocols of the CXL protocol. The command address C_ADDR may be transmitted using the second protocol PTC2, for example, the non-coherent protocol CXL.io or the I/O protocol IO among the low-ranked protocols of the CXL protocol.

Therefore, only the several bytes of the address may be rapidly transmitted to the second device 33 from the first device 31 compared to when the command CMD is transmitted through the second protocol PTC2.

As a result, the command and the data may be directly transmitted to the memory region of the device where the calculation may be off-road. Thus, a large size of the command may be effectively transmitted to improve the data processing capacity.

The above described embodiments of the present invention are intended to illustrate and not to limit the present invention. Various alternatives and equivalents are possible. The invention is not limited by the embodiments described herein. Nor is the invention limited to any specific type of semiconductor device. Other additions, subtractions, or modifications are apparent in view of the present disclosure and are intended to fall within the scope of the appended claims. Furthermore, the embodiments may be combined to form additional embodiments.

What is claimed is:

1. An interface device for interfacing a communication between a first device and a second device, the interface device comprising:
a first element configured to receive a first packet from the first device based on a first protocol and transmit the first packet to the second device, wherein the first packet includes a command, and
a second element configured to receive a second packet from the first device based on a second protocol different from the first protocol and transmit the second packet to the second device, wherein the second packet includes a command address representing a storage position of the command.

2. The interface device of claim 1, wherein the first protocol and the second protocol are a low-ranked protocol of a compute express link (CXL) protocol.

3. The interface device of claim 1, wherein the first protocol is a CXL.mem protocol supported by a compute express link (CXL) protocol.

4. The interface device of claim 1, wherein the second protocol is a CXL.io protocol supported by a compute express link (CXL) protocol.

5. The interface device of claim 1, wherein the first packet further comprises data.

6. A data computing device comprising:
an interface device configured to receive a first packet from a first device based on a first protocol and to receive a second packet from the first device based on a second protocol different from the first protocol, wherein the first packet includes a command, and the second packet includes a command address representing a storage position of the command;
a device memory including the storage position;
a processor configured to parse the first packet to extract the command and to store the command in the device memory and parse the second packet to extract the command address; and
a memory controller configured to access to the device memory based on the command address parsed by the processor to execute the command.

7. The data computing device of claim 6, wherein the first protocol and the second protocol are a low-ranked protocol of a compute express link (CXL) protocol.

8. The data computing device of claim 6, wherein the first protocol is a CXL.mem protocol supported by a compute express link (CXL) protocol.

9. The data computing device of claim 6, wherein the second protocol is a CXL.io protocol supported by a compute express link (CXL) protocol.

10. The data computing device of claim 6, wherein the first packet further comprises data.

11. A data processing system comprising:
a first device; and
a second device,
wherein the second device comprises an interface device and a processor,
wherein the interface device is configured to: receive an off-road calculation request from the first device, receive a first packet based on a first protocol, and receive a second packet from the first device based on a second protocol different from the first protocol, the first packet including a command, the second packet including a command address representing a storage position of the command, and
wherein the processor is configured to: parse the first packet and the second packet to process the off-road calculation request.

12. The data processing system of claim 11, further comprising a device memory configured to store the command.

13. The data processing system of claim 12, wherein the first device comprises a plurality of devices and the device memory is shared with at least part of the plurality of devices.

14. The data processing system of claim 11, wherein the first device comprises a plurality of devices and the second device is shared with at least part of the plurality of devices.

15. The data processing system of claim 11, wherein the first protocol and the second protocol are a low-ranked protocol of a compute express link (CXL) protocol.

16. The data processing system of claim 11, wherein the first protocol is a CXL.mem protocol supported by a compute express link (CXL) protocol.

17. The data processing system of claim 11, wherein the second protocol is a CXL.io protocol supported by a compute express link (CXL) protocol.

18. An interface method for interfacing between a first device and a second device, the interface method comprising:
receiving a first packet from the first device based on a first protocol by the second device, wherein the first packet includes a command; and
receiving a second packet from the first device based on a second protocol different from the first protocol by the second device, wherein the second packet includes a command address representing a storage position of the command.

19. The interface method of claim 18, wherein the first protocol and the second protocol are a low-ranked protocol of a compute express link (CXL) protocol.

20. The interface method of claim 18, wherein the first packet further comprises data.
